(19) United States
(12) Patent Application Publication
(10) Pub. No.: US 2010/0095805 A1
(43) Pub. Date: Apr. 22, 2010

(54) Plate elements for preventing rotary shafts of shredder from bending

(75) Inventor: Jia-Wang Jiang, NingBo City (CN)

Correspondence Address: BACON & THOMAS, PLLC, 625 SLATERS LANE, FOURTH FLOOR, ALEXANDRIA, VA, 22314-1176, US

(73) Assignee: Michilin Prosperity Co., Ltd., SanChung City (TW)

(21) Appl. No.: 12/289,049

(22) Filed: Oct. 20, 2008

(51) Int. Cl. F16P 1/00

(52) U.S. Cl. 74/608

(57) ABSTRACT

This specification discloses plate elements that prevent the rotary shafts of the shredder from bending. The plate elements are fixed on the frame by their two ends. They are disposed in parallel on both sides of the shredder mechanism. The plate element is basically a wavy plate to provide a better strength. Through the pinching effect of the plate element on the shredder mechanism, the rotary shafts are prevented from bending deformation under external forces.

### BACKGROUND OF THE INVENTION

1. Field of Invention

The invention relates to a shredder and, in particular, to plate elements that prevent the rotary shafts of the shredder from bending.

2. Related Art

To prevent such documents as legal files, receipts, invoices, credit card numbers, research reports, or personal financial information (e.g., credit card and phone bills) from being released, it is common to destroy them using a shredder. Therefore, the shredder has become an indispensable device for both business and home applications.

A usual shredder includes a housing, a paper inlet on the front surface of the housing for inserting paper, and a shredder mechanism disposed inside the housing for shredding paper. The shredder mechanism includes cutting blades mounted on two parallel rotary shafts driven by a motor and a gearbox, thereby cutting passing paper into stripes or chips.

Any given shredder has a sheet capacity according to its motor load and the strengths of the cutting blades and rotary shafts. When a lot of paper needs to be destroyed, the user has to follow the sheet capacity when inserting paper. Otherwise, inserting too much paper at a time can easily cause a paper jam. Moreover, the rotary shafts may bend when it is overloaded. If no appropriate supporting components are provided on the outer sides of the rotary shafts to balance the bending moment, the rotary shafts may even break, making the shredder out of order.

Therefore, to prevent the rotary shafts from bending under a large external force, it is necessary to provide appropriate supporting components on the outer sides of the rotary shafts.

### SUMMARY OF THE INVENTION

In view of the foregoing, an objective of the invention is to provide plate elements to prevent the rotary shafts from bending.

To achieve the above objective, plate elements that prevent the rotary shafts from bending are fixed on a frame and disposed in parallel with ends resting on both sides of the shredder mechanism. The plate element is basically a wavy plate in order to provide a better strength. Through the pinching effect of the plate element on the shredder mechanism, the rotary shafts are prevented from bending deformation under external forces.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the invention;

FIG. 2 is a cross-sectional view of the disclosed structure; and

FIG. 3 is a three-dimensional view of the disclosed plate element.

### DETAILED DESCRIPTION OF THE INVENTION

The present invention will be apparent from the following detailed description, which proceeds with reference to the accompanying drawings, wherein the same references relate to the same elements.

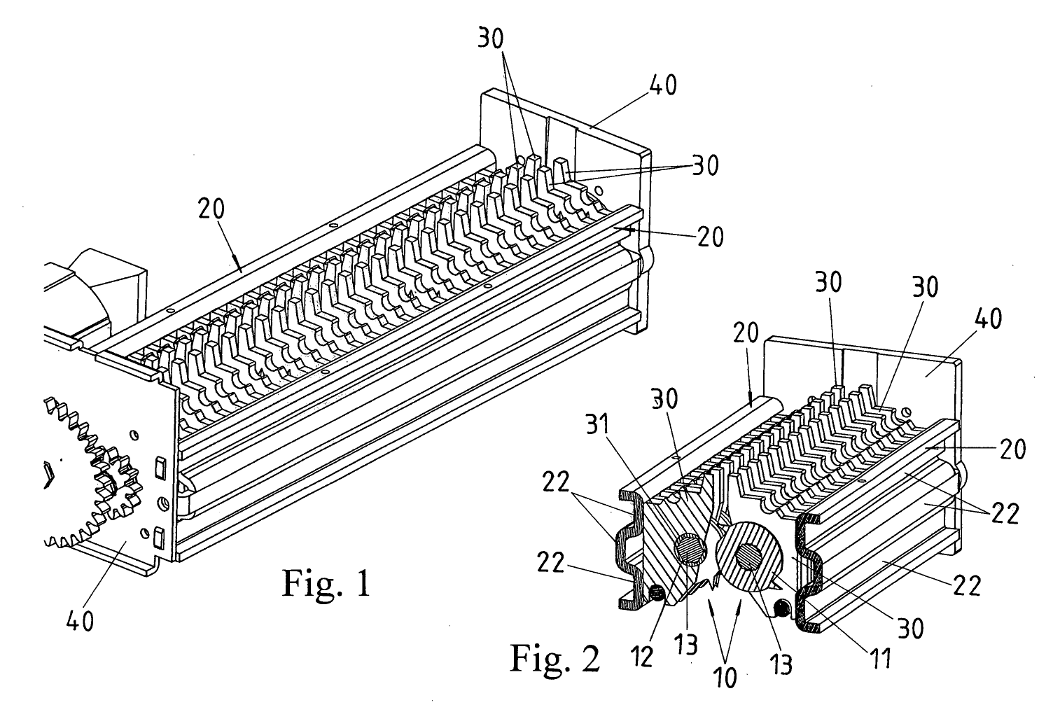

As shown in FIGS. 1 and 2, the shredder mechanism 10 disposed in the frame 40 includes cutting blades 11 mounted on the rotary shafts 13, spacer rings 12, and paper guiding chips 30. A motor and a gearbox drive the two parallel rotary shafts 13 to rotate in opposite directions. The passing paper is then cut into stripes or chips.

If the user inserts too much paper into the paper inlet of the shredder and the paper enters the shredder mechanism, the cutting blades 11 may stop due to a paper jam. In this case, the rotary shafts 13 bend outward due to overloading. If no appropriate supporting components are provided on the outer sides of the rotary shafts 13 to balance the bending moment, the rotary shafts 13 may even break, making the shredder out of order.

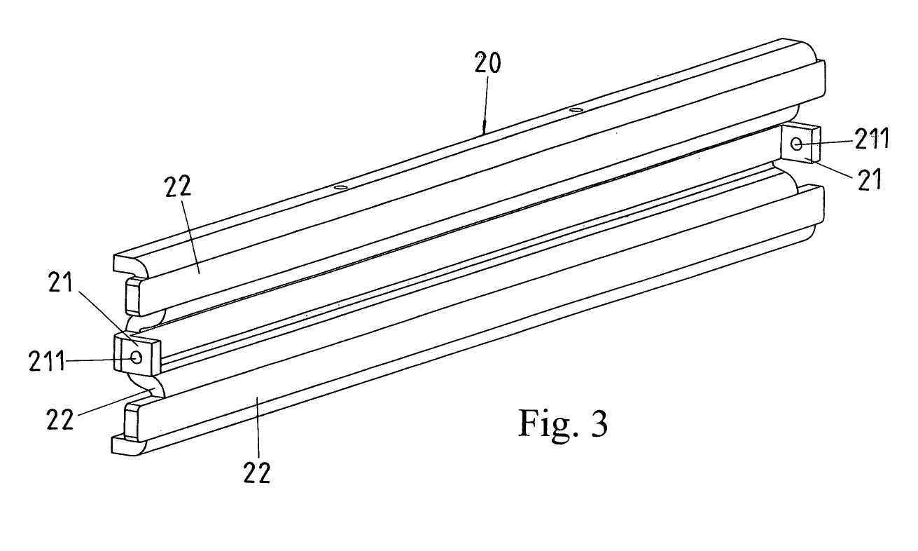

Please refer to FIG. 3. The plate element 20 for preventing the rotary shafts from bending is disposed in parallel with ends resting on both sides of the shredder mechanism 10. The plate element 20 is basically a wavy plate 22 in order to provide a better strength. Its both ends are fixed on the frame 40 by screw pads 21, screw holes 211, and screws. The plate elements 20 thus urge against the borders of the paper guiding chips 31, thereby pinching the shredder mechanism. Therefore, it achieves the foal of preventing the rotary shafts 13 from bending under external forces.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. A shaft bending prevention mechanism including plate plate elements for preventing parallel rotary shafts of a shredder from bending,
said shredder comprising:
a frame; and
a shredder mechanism, which is disposed on the frame and includes: two said parallel rotary shafts that respectively extend between sides of the frame, cutting blades mounted on said rotary shafts, spacer rings, and paper guiding members having distal edges that face away from the rotary shafts, wherein the rotary shafts are driven by a motor and a gear box to rotate in opposite directions to shred passing paper into stripes or chips; and
said shaft bending prevention mechanism comprising:
said plate elements, which are fixed on the frame and disposed in parallel with said shafts, said plate elements having ends fixed to said sides of the frame and arranged to engage said paper guides at two discrete sections of said distal edges of the paper guiding members to thereby prevent said shafts from bending.

2. A shaft bending prevention mechanism including a plate elements for preventing rotary shafts of a shredder from bending as in claim 1, wherein the plate element is a wavy plate to provide a better strength.

3. A shaft bending prevention mechanism including a plate elements for preventing rotary shafts of a shredder from bending as in claim 1, wherein both ends of the plate elements are fixed on the frame by screw pads, screw holes, and screws.

4. A shaft bending prevention mechanism including a plate elements for preventing rotary shafts of a shredder from bending as in claim 1, wherein the plate elements urge against edges of the paper guiding members.
